(19) United States
(12) Patent Application Publication
(10) Pub. No.: US 2025/0039837 A1
(43) Pub. Date: Jan. 30, 2025

(54) APPARATUS, METHODS, AND COMPUTER PROGRAMS

(71) Applicant: Nokia Technologies Oy, Espoo (FI)

(72) Inventors: Dileep KUMAR, Espoo (FI); Onel ALCARAZ LÓPEZ, Oulu (FI); Carlos DE LIMA, Oulu (FI); Antti TÖLLI, Oulu (FI); Juha Pekka KARJALAINEN, Oulu (FI)

(21) Appl. No.: 18/715,869

(22) PCT Filed: Dec. 3, 2021
(86) PCT No.: PCT/EP2021/084209

§ 371 Date: Jun. 3, 2024

(51) Int. Cl. H04W 64/00; G01S 5/02; H04B 7/06; H04W 16/28; H04W 24/10

(52) U.S. Cl. CPC H04W 64/003; G01S 5/0284; H04B 7/06; H04W 16/28; H04W 24/10

(57) ABSTRACT

There is provided an method, apparatus, and computer program that causes a first apparatus to: perform first positioning measurements using beamforming on transmissions made by a first user equipment to obtain first soft positioning information relating to the location of the first user equipment; and provide the first soft positioning information to at least one of a second apparatus and/or a location function located in a core network.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

There is a need to provide control systems which enable a communications service provider (CSP) to control and optimise a complex network of communications system elements.

One of current approaches being employed is closed-loop automation and machine learning which can be built into self-organizing networks (SON) enabling an operator to automatically optimize every cell in the radio access network.

### SUMMARY

According to a first aspect, there is provided an apparatus for a first apparatus, the apparatus comprising means for: performing first positioning measurements using beamforming on transmissions made by a first user equipment to obtain first soft positioning information relating to the location of the first user equipment; and providing the first soft positioning information to at least one of a second apparatus and/or a location function located in a core network.

The apparatus may comprise means for: receiving second soft positioning information from the second apparatus; and generating the first soft positioning information by modifying soft positioning information derived independently using said first positioning measurements using the second soft positioning information.

The apparatus may comprise means for: determining the relative locations of the first and/or second apparatus; and generating the first soft positioning information using said determined relative locations of the first and/or second apparatus.

The apparatus may comprise means for: determining the relative locations of the first and/or second apparatus; and providing the determined relative locations to the location function.

The apparatus may comprise means for: providing, to the location function, indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may comprise means for: receiving, from the location function, an instruction to obtain soft positioning measurements in respect of the first user equipment before said providing the first positioning measurements.

The apparatus may comprise means for: receiving, from the location function and/or a coordinating access point, a configuration for obtaining the first positioning measurements.

At least one of the first and/or second apparatus may be an access point and/or a user equipment.

According to a second aspect, there is provided an apparatus for a location function, the apparatus comprising means for: receiving, from a first apparatus, first soft positioning information relating to positioning measurements performed by said first apparatus, wherein the first soft positioning information relates to a location of a first user equipment; and determining the location of the first user equipment using a determined location of the first apparatus in combination with the first soft positioning information.

The first soft positioning information may comprise second soft positioning information relating to positioning information measurements performed by a second apparatus.

The apparatus may comprise means for: receiving, from a second apparatus, second soft positioning information relating to positioning measurements performed by said second apparatus, wherein the second soft positioning information relates to a location of a first user equipment; wherein said determining the location of the first user equipment is further performed using a determined location of the second apparatus in combination with the second soft positioning information.

The apparatus may comprise means for: receiving at least one of a location of the first apparatus and/or a location of the second apparatus.

The apparatus may comprise means for: receiving, from the first apparatus an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may comprise means for: signalling, to the first apparatus equipment before said first positioning measurements are received, an instruction to obtain soft positioning measurements in respect of the first user.

The apparatus may comprise means for: transmitting, to the first apparatus before the first positioning measurements are received, a configuration for obtaining the first positioning measurements.

At least one of the first and/or second apparatus may be an access point and/or a user equipment.

According to a third aspect, there is provided an apparatus for a first apparatus, the apparatus comprising: at least one processor, and at least one memory comprising code that, when executed by the at least one processor, causes the apparatus to: perform first positioning measurements on using beamforming on transmissions made by a first user equipment to obtain first soft positioning information relating to the location of the first user equipment; and provide the first soft positioning information to at least one of a second apparatus and/or a location function located in a core network.

The apparatus may be caused to: receive second soft positioning information from the second apparatus; and generate the first soft positioning information by modifying soft positioning information derived independently using said first positioning measurements using the second soft positioning information.

The apparatus may be caused to: determine the relative locations of the first and/or second apparatus; and generate the first soft positioning information using said determined relative locations of the first and/or second apparatus.

The apparatus may be caused to: determine the relative locations of the first and/or second apparatus; and provide the determined relative locations to the location function.

The apparatus may be caused to: provide, to the location function, indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may be caused to: receive, from the location function, an instruction to obtain soft positioning measurements in respect of the first user equipment before said providing the first positioning measurements.

The apparatus may be caused to: receive, from the location function and/or a coordinating access point, a configuration for obtaining the first positioning measurements.

At least one of the first and/or second apparatus may be an access point and/or a user equipment.

According to a fourth aspect, there is provided an apparatus for a location function, the apparatus comprising: at least one processor, and at least one memory comprising code that, when executed by the at least one processor, causes the apparatus to: receive, from a first apparatus, first soft positioning information relating to positioning measurements performed by said first apparatus, wherein the first soft positioning information relates to a location of a first user equipment; and determine the location of the first user equipment using a determined location of the first apparatus in combination with the first soft positioning information.

The first soft positioning information may comprise second soft positioning information relating to positioning information measurements performed by a second apparatus.

The apparatus may be caused to: receive, from a second apparatus, second soft positioning information relating to positioning measurements performed by said second apparatus, wherein the second soft positioning information relates to a location of a first user equipment; wherein said determining the location of the first user equipment is further performed using a determined location of the second apparatus in combination with the second soft positioning information.

The apparatus may be caused to: receive at least one of a location of the first apparatus and/or a location of the second apparatus.

The apparatus may be caused to: receive, from the first apparatus, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may be caused to: signal, to the first apparatus equipment before said first positioning measurements are received, an instruction to obtain soft positioning measurements in respect of the first user.

The apparatus may be caused to: transmit, to the first apparatus before the first positioning measurements are received, a configuration for obtaining the first positioning measurements.

At least one of the first and/or second apparatus may be an access point and/or a user equipment.

According to a fifth aspect, there is provided a method for an apparatus for a first apparatus, the method comprising: performing first positioning measurements using beamforming on transmissions made by a first user equipment to obtain first soft positioning information relating to the location of the first user equipment; and providing the first soft positioning information to at least one of a second apparatus and/or a location function located in a core network.

The method may comprise: receiving second soft positioning information from the second apparatus; and generating the first soft positioning information by modifying soft positioning information derived independently using said first positioning measurements using the second soft positioning information.

The method may comprise: determining the relative locations of the first and/or second apparatus; and generating the first soft positioning information using said determined relative locations of the first and/or second apparatus.

The method may comprise: determining the relative locations of the first and/or second apparatus; and providing the determined relative locations to the location function.

The method may comprise providing, to the location function, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The method may comprise: receiving, from the location function, an instruction to obtain soft positioning measurements in respect of the first user equipment before said providing the first positioning measurements.

The method may comprise: receiving, from the location function and/or a coordinating access point, a configuration for obtaining the first positioning measurements.

At least one of the first and/or second apparatus may be an access point and/or a user equipment.

According to a sixth aspect, there is provided a method for an apparatus for a location function, the method comprising: receiving, from a first apparatus, first soft positioning information relating to positioning measurements performed by said first apparatus, wherein the first soft positioning information relates to a location of a first user equipment; and determining the location of the first user equipment using a determined location of the first apparatus in combination with the first soft positioning information.

The first soft positioning information may comprise second soft positioning information relating to positioning information measurements performed by a second apparatus.

The method may comprise: receiving, from a second apparatus, second soft positioning information relating to positioning measurements performed by said second apparatus, wherein the second soft positioning information relates to a location of a first user equipment; wherein said determining the location of the first user equipment is further performed using a determined location of the second apparatus in combination with the second soft positioning information.

The method may comprise: receiving at least one of a location of the first apparatus and/or a location of the second apparatus.

The method may comprise: receiving, from the first apparatus, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The method may comprise: signalling, to the first apparatus equipment before said first positioning measurements are received, an instruction to obtain soft positioning measurements in respect of the first user.

The method may comprise: transmitting, to the first apparatus before the first positioning measurements are received, a configuration for obtaining the first positioning measurements.

At least one of the first and/or second apparatus may be an access point and/or a user equipment.

According to a seventh aspect, there is provided an apparatus for a first apparatus, the apparatus comprising: performing circuitry for performing first positioning measurements using beamforming on transmissions made by a first user equipment to obtain first soft positioning information relating to the location of the first user equipment; and providing circuitry for providing the first soft positioning information to at least one of a second apparatus and/or a location function located in a core network.

The apparatus may comprise: receiving circuitry for receiving second soft positioning information from the second apparatus; and generating circuitry for generating the first soft positioning information by modifying soft positioning information derived independently using said first positioning measurements using the second soft positioning information.

The apparatus may comprise: determining circuitry for determining the relative locations of the first and/or second apparatus; and generating circuitry for generating the first soft positioning information using said determined relative locations of the first and/or second apparatus.

The apparatus may comprise: determining circuitry for determining the relative locations of the first and/or second apparatus; and providing circuitry for providing the determined relative locations to the location function.

The apparatus may comprise: providing circuitry for providing, to the location function, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may comprise: receiving circuitry for receiving, from the location function, an instruction to obtain soft positioning measurements in respect of the first user equipment before said providing the first positioning measurements.

The apparatus may comprise: receiving circuitry for receiving, from the location function and/or a coordinating access point, a configuration for obtaining the first positioning measurements.

At least one of the first and/or second apparatus may be an access point and/or a user equipment.

According to an eighth aspect, there is provided an apparatus for a location function, the apparatus comprising: receiving circuitry for receiving, from a first apparatus, first soft positioning information relating to positioning measurements performed by said first apparatus, wherein the first soft positioning information relates to a location of a first user equipment; and determining circuitry for determining the location of the first user equipment using a determined location of the first apparatus in combination with the first soft positioning information.

The first soft positioning information may comprise second soft positioning information relating to positioning information measurements performed by a second apparatus.

The apparatus may comprise: receiving circuitry for receiving, from a second apparatus, second soft positioning information relating to positioning measurements performed by said second apparatus, wherein the second soft positioning information relates to a location of a first user equipment; wherein said determining the location of the first user equipment is further performed using a determined location of the second apparatus in combination with the second soft positioning information.

The apparatus may comprise: receiving circuitry for receiving at least one of a location of the first apparatus and/or a location of the second apparatus.

The apparatus may comprise: receiving circuitry for receiving, from the first apparatus, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may comprise: signalling circuitry for signalling, to the first apparatus equipment before said first positioning measurements are received, an instruction to obtain soft positioning measurements in respect of the first user.

The apparatus may comprise: transmitting circuitry for transmitting, to the first apparatus before the first positioning measurements are received, a configuration for obtaining the first positioning measurements.

At least one of the first and/or second apparatus may be an access point and/or a user equipment.

According to a ninth aspect, provided non-transitory computer readable medium comprising program instructions for causing an apparatus for a first apparatus to perform at least the following: perform first positioning measurements using beamforming on transmissions made by a first user equipment to obtain first soft positioning information relating to the location of the first user equipment; and provide the first soft positioning information to at least one of a second apparatus and/or a location function located in a core network.

The apparatus may be caused to: receive second soft positioning information from the second apparatus; and generate the first soft positioning information by modifying soft positioning information derived independently using said first positioning measurements using the second soft positioning information.

The apparatus may be caused to: determine the relative locations of the first and/or second apparatus; and generate the first soft positioning information using said determined relative locations of the first and/or second apparatus.

The apparatus may be caused to: determine the relative locations of the first and/or second apparatus; and provide the determined relative locations to the location function.

The apparatus may be caused to: provide, to the location function, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may be caused to: receive, from the location function, an instruction to obtain soft positioning measurements in respect of the first user equipment before said providing the first positioning measurements.

The apparatus may be caused to: receive, from the location function and/or a coordinating access point, a configuration for obtaining the first positioning measurements.

At least one of the first and/or second apparatus may be an access point and/or a user equipment.

According to a tenth aspect, provided non-transitory computer readable medium comprising program instructions for causing an apparatus for a location function to perform at least the following: receive, from a first apparatus, first soft positioning information relating to positioning measurements performed by said first apparatus, wherein the first soft positioning information relates to a location of a first user equipment; and determine the location of the first user equipment using a determined location of the first apparatus in combination with the first soft positioning information.

The first soft positioning information may comprise second soft positioning information relating to positioning information measurements performed by a second apparatus.

The apparatus may be caused to: receive, from a second apparatus, second soft positioning information relating to positioning measurements performed by said second apparatus, wherein the second soft positioning information relates to a location of a first user equipment; wherein said determining the location of the first user equipment is further performed using a determined location of the second apparatus in combination with the second soft positioning information.

The apparatus may be caused to: receive at least one of a location of the first apparatus and/or a location of the second apparatus.

The apparatus may be caused to: receive, from the first apparatus, an indication of an identifier associated with a parameter vector for generating a beamforming pattern or patterns on which the first positioning measurements are based.

The identifier may comprise an indication of a circular shift of a root sequence used for obtaining a codebook on which the first positioning measurements are based.

The apparatus may be caused to: signal, to the first apparatus equipment before said first positioning measurements are received, an instruction to obtain soft positioning measurements in respect of the first user.

The apparatus may be caused to: transmit, to the first apparatus before the first positioning measurements are received, a configuration for obtaining the first positioning measurements.

At least one of the first and/or second apparatus may be an access point and/or a user equipment.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Examples will now be described, by way of example only, with reference to the accompanying Figures in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6A and 6B are schematic diagrams illustrating example network configurations;

FIG. 7 indicates a probability distribution against an Angle of Arrival;

FIGS. 8A and 8B illustrate example network geometrical configurations;

FIGS. 9 and 10 illustrate example operations that may be performed by apparatus described herein;

FIG. 11 illustrates how the proposed mechanism(s) compares against other mechanisms as the number of measurement increases;

FIG. 12 illustrates an example radiation pattern;

FIG. 13 illustrates the generation of soft information on the location of a user equipment by a first and second access point and the use of relative positioning information therebetween for refining this soft information;

FIG. 14 illustrates example network connections;

FIGS. 15 to 16 are flow charts illustrating potential operations that may be performed by apparatus described herein; and

FIG. 17 illustrates how geometrical factors may refine the soft information from independent measurements.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals).

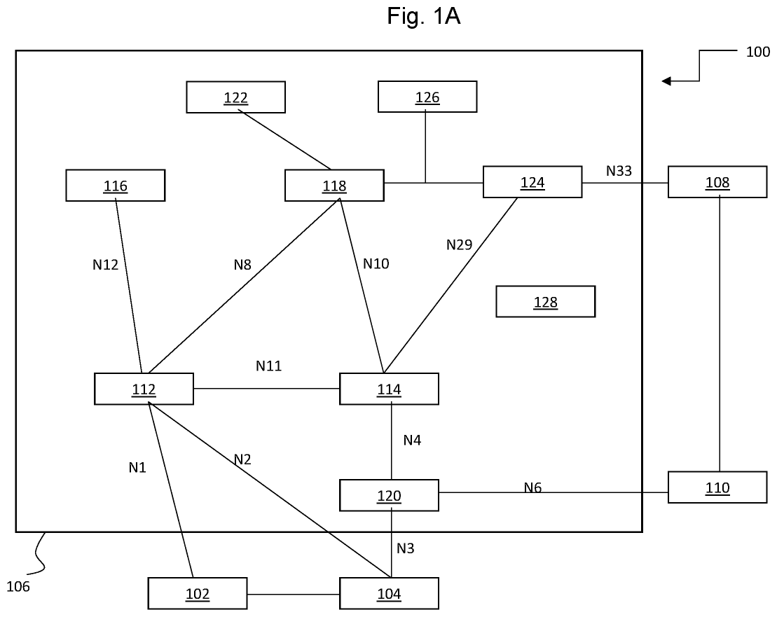

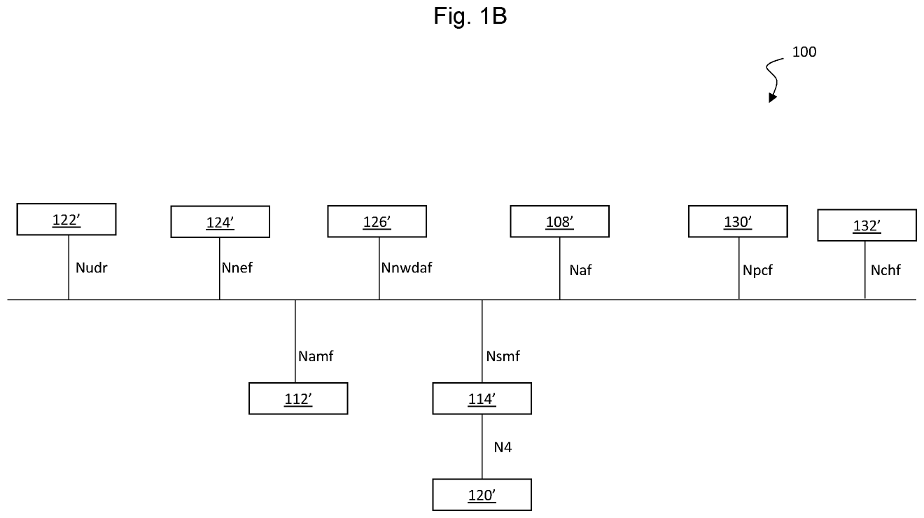

Before explaining in detail the exemplifying embodiments, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, etc.) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS). The MDAS may provide data analytics of different network related parameters including for example load level and/or resource utilisation. For example, the MDAS for a network function (NF) can collect the NF's load related performance data, e.g., resource usage status of the NF. The analysis of the collected data may provide forecast of resource usage information in a predefined future time. This analysis may also recommend appropriate actions e.g., scaling of resources, admission control, load balancing of traffic, etc.

FIG. 1B shows a schematic representation of a 5GC 106′ represented in current 3GPP specifications.

FIG. 1B shows a UPF 120′ connected to an SMF 114′ over an N4 interface. The SMF 114′ is connected to each of a UDR 122′, an NEF 124′, an NWDAF 126′, an AF 108′, a Policy Control Function (PCF) 130′, an AMF 112′, and a Charging function 132′ over an interconnect medium that also connects these network functions to each other.

3GPP refers to a group of organizations that develop and release different standardized communication protocols. 3GPP is currently developing and publishing documents related to Release 16, relating to 5G technology, and Releases 17 and 18.

3GPP New Radio (NR) in Release 16 provides support for different positioning methods (e.g., based on time, angle, and/or phase measurements) to satisfy requirements of regulatory, as well as commercial, use cases. The ultimate goal of providing such support is to attain low-latency, high-accuracy, and robust positioning capabilities for various vertical services, while supporting the corresponding requirements of the standard with which these apparatuses are compliant, such as various versions of 3GPP TS 22.261. To this end, New Radio (NR) positioning mechanisms in Release 17 and beyond are intended to both enhance current specification, as well as introduce novel measurements techniques and reporting mechanisms to meet the following typical performance targets for the different use cases:
(a) For general commercial use cases (e.g., 3GPP TS 22.261), a target position accuracy <1 metre.
(b) For industrial automation, Industrial Internet of Things (IIoT) use cases (e.g., 3GPP TS 22.804), a target position accuracy <0.2 metre.

With respect to the target latency, a typical requirement for the IIoT use cases is <100 ms, while some specific deployment scenarios may require even shorter latency (e.g. in the order of 10 ms). However, the current positioning methods (e.g., based on sequential/directional scanning and acquiring the positioning parameters) may not be able to meet such requirements, as shown by the evaluation results in 3GPP Technical Report (TR) 36.855 and 3GPP TR 37.857. These problems are illustrated further in the discussion and Figures below.

The reference positioning architecture may comprise User Equipment (UE), Radio Access Network (RAN), and Central Unit (CU)/Core Network (CN) components that facilitate access to at least one positioning server and positioning service clients (i.e. an entity requesting positioning information from the positioning server). The localization information can be requested by and/or reported to a UE or the core network (e.g., the Location Management Function (LMF)).

In current 3GPP work, the gNB and target UE are assumed to communicate through both Line of Sight (LoS) and Non-Line of Sight (NLOS) beams, where LoS refers to direct transmissions and NLOS refers to indirect transmissions (e.g. reflected transmissions). Additionally, there are unknown scatterers (e.g. reflective surfaces and/or refractive objects) that can be associated with each beam per link between gNB and target UEs.

3GPP currently specifies control plane and signalling strategies to exchange the positioning information between the UE, the network nodes, and the positioning server. Release 16 already provides support for several network-(and UE)-based positioning techniques for downlink (DL) and uplink (UL), e.g., Relative time of arrival (RTOA) UL/DL-Angle of Arrival (AoA), UL/DL-Observed time difference of arrival (OTDOA). As an example, each Synchronization signal block (SSB) has a unique index number which is mapped to a specific DL TX beam and is thus transmitted in a specific direction. A UE receiving such SSBs measures the signal strength of each received SSB and identifies the best serving beam as the one that matches the index of pre-defined and pre-configured criteria, such as, for example the strongest received signal. These positioning techniques require that the UE-gNB pair perform sequential beam sweeping for the associated reference signal transmissions and acquire required positioning parameters (e.g., parameters related to time, angle, and phase). The acquired measurements are used to compute the position coordinates of the target UE, and a quantized version of such information is then provided to the requesting entity.

5G NR utilizes millimeter-wave (mmWave) based radio access technology, which may be transmitted at higher frequencies than, for example, 4G technologies. Due to the utilization of such high carrier frequencies, large antenna arrays are used to compensate for the impact of large pathloss between a gNB and a UE, as well as to enable targeted coverage for a serving gNB. The combination of the use of these large antenna arrays and wide system bandwidths allows for, respectively, higher angular resolution and higher time resolution, in NR than can be achieved with smaller antenna arrays and narrower system bandwidths, such as in traditional cellular systems.

The positioning mechanism in Release 16 currently assigns unique downlink positioning reference signals (PRS) or uplink sounding reference signals (SRS) to each directional beam at gNB and target UE to assist in positioning mechanisms. To summarize, 5G NR can localize a target UE with sub-meter level accuracy by associating the reference signals (PRS/SRS) over the directional beams. However, such highly directional communication configuration may lead to the following key issues:

First, the gNB/UE is configured to exhaustively scan a complete (or a large portion of) beamforming codebook for obtaining the required measurements and positioning parameters for determining a position of a UE. This is also referred to as sequential beam sweeping for the associated SRS/PRS pilot transmissions. However, these predefined/periodic transmissions of the reference signals lead not only to a large training overhead and inefficient utilization of the limited positioning resources, but also to unnecessary energy consumption at the target UEs. This sweeping over a large portion of beamforming codebook may also result in a significant large delay to accumulate all the required measurements. These disadvantages can impact the usefulness of its application to a variety of cases. For example, such positioning mechanisms may not be suitable for mobile scenarios that impose a strict timing constraint. Specifically, due to the mobility of UE and moving scattering obstacles (e.g. a car) in the propagation environment, the positioning parameters underlying the acquired measurements vary dynamically in subsequent scanning time slots.

Second, the gNB and/or a Location Management Function in the 5GC is configured to use the acquired positioning measurements to estimate the position coordinates of the target UE, and then provide a quantized version of such information to the requesting entity. In doing so, the existing method does not fully exploit the acquired measurements such as, for example, the underlying distribution of the position parameters due to multi-path propagations and known geometry of the transceiver dispositions. Such hard/quantised decisions on UE location (or parameters), in general, may potentially lead to unavoidable miss-matches in positioning (e.g., in LOS and obstructed-LoS (NLoS) conditions).

Third, mmWave communication links are intrinsically highly susceptible to path blockage due to the high pathloss and penetration loss. In these configurations, the unavailability of a dominant (e.g. LoS) link between the gNB and the UE generally leads to the radio link failure between the UEs and the gNB (and/or UE becomes unreachable by some gNB). Furthermore, the achievable positioning accuracy with only NLOS paths is below the performance targets currently specified by 3GPP TR 36.855 and 3GPP TR 37.857. Thus, the UE cannot be accurately localized by the network.

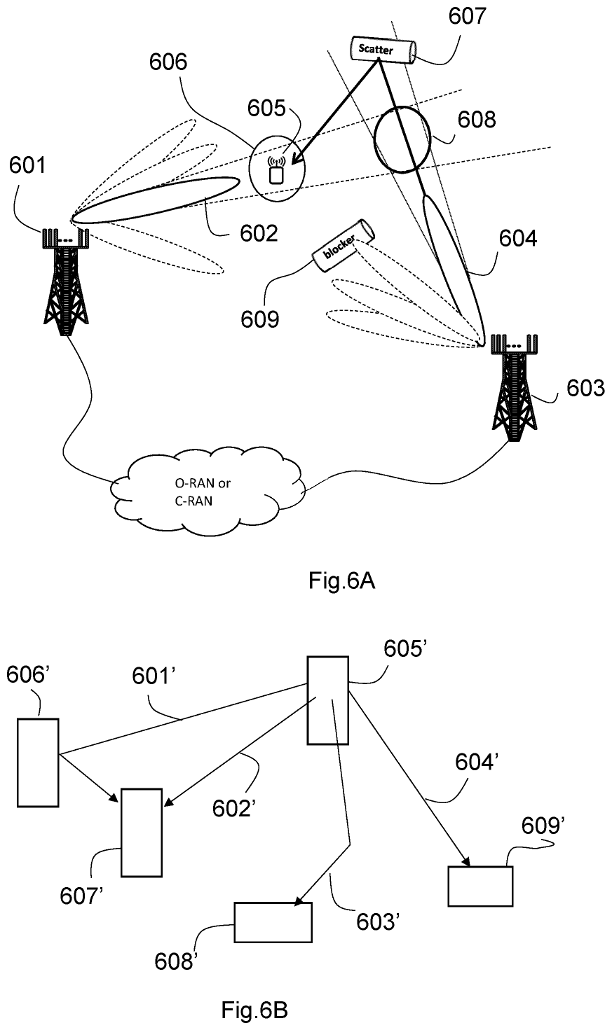

These aspects are illustrated with respect to FIGS. 6A and 6B, which illustrate beam-based positioning procedures.

FIG. 6A illustrates a first access point 601 (e.g. a gNB) that transmits a first positioning signal using a directed beam 602 for determining the position of a UE 605 located at 606, and a second access point 603 (e.g. a gNB) that transmits a second positioning signal 604 for determining the position of the UE 605. As can be seen in FIG. 6, this second positioning signal 604 is reflected off at least one surface 607, causing the direction of the second positioning signal 604 to change. If this scattering/reflection is unknown, this may cause the UE's position to be determined to be 608 instead of location 606, where there is no overlap between locations 608 and 606. Also illustrated is a blocker, 609, which is an object that prevents incident signals from passing through.

FIG. 6B illustrates positioning signals 601′, 602′, 603′, 604′ transmitted by an access point 605′. A first of these positioning signals 601′ is reflected off a building 606′ such that the primary direction of the positioning signal 601′ is changed by its reflection. A second of these positioning signals 602′ is blocked by blocker 607′ (e.g. a person). A third of these positioning signals 603′ arrives at user 608′ following an indirect (aka a non-linear or a non-line of sight) path (e.g. after reflecting off the ground/obstacle). A fourth of these positioning signals 604′ arrives at user 609′ following a direct (aka linear or a line of sight) path.

The illustrated positioning signals of FIGS. 6A and 6B are mostly limited to the typical methods as define in the 3GPP specifications, so that the above-mentioned issues like the extensive sequential beam sweeping for acquiring measurements (which may comprise exhaustive sequential beam sweeping or an otherwise large amount of sequential beam sweeping), hard decision methods on positioning, and increasingly stringent QoS requirements affect them. However, these techniques have been developed for other wavelengths, such as microwave frequencies, and consequently are not optimised for mmWave channel conditions.

For example, mWave channels have been shown to exhibit sparsity in the angle and delay domains, which in some cases may not be encountered in microwave frequencies. A channel may be considered to be sparse when its discrete impulse response is sparse, which means that there are more zero-valued responses (or close to zero responses) than non-zero responses. The term sparse in this context, in general, means that there are more elements that are zero valued or very close to zero in comparison to the number of non-zero values. In a further example, sparse may be used to describe a channel where the estimated positioning parameters (e.g. e.g. parameters related to time, angle, and phase) may be observed to be diverse and/or random.

Consequently, these known positioning techniques are unable to exploit the mmWave channel sparsity, potential LoS/NLOS components, and network geometry of transceivers dispositions, while accumulating the radio measurements between the gNBs and target UEs. They may thus result in higher training overhead and also perform poorly in the presence of random link blockage and deep fading channel conditions, as shown in FIGS. 6A and 6B.

This limitation becomes a relevant problem for public safety and IloT applications when the terminal requires very accurate and fast positioning capability. Specifically, ubiquitous and low-delay positioning is often a prerequisite in such deployment scenarios. Hence, there is a strong need to develop new techniques for the estimation of positioning parameters.

To this effect, the following is directed towards providing at least one technique for estimating at least one positioning parameter via coarse non-directional measurements, and at least one new reporting mechanism for gNB and/or target UE(s) that can enable high accuracy positioning, e.g., exploiting the local soft measurements and geometric disposition of the transceivers of the gNB and/or target UE(s).

The following may be particularly useful in providing 3GPP NR Radio Access Technology (RAT) enhancement(s) for Release 17 and beyond systems, although it is understood that these techniques are not limited to these systems. More specifically, the following aims to provide a low-latency, high-accuracy, and robust positioning method for wireless channels (e.g. channels exhibiting a sparse response, and may be sometimes referred as sparse channels). This may be performed, for example, by exploiting multi-antenna spatial diversity via geographically separated access points/gNBs. The proposed framework is based on sparse estimation of positioning parameters i.e. estimation of positioning parameters that are made using fewer random-like measurements (e.g. using pseudo random antenna pattern) of the links compared to previous techniques and using non-directional scanning of the access link directions. The following further discloses a process of soft estimating parameters locally at an access point/gNB, and then exploiting the geometric disposition of transceivers in the system that are transmitting and/or receiving positioning signals for deriving those parameters to more accurately determine an absolute position of the target UE.

Specifically, due to the sparse response nature of the radio propagation channel (e.g. mmWave but not limited to that), the following proposes to first carry out soft local estimate of the positioning parameters based on few properly designed random-like measurements in the access links, and then perform a geometry-aided positioning of the UE. This may be performed using the following principles.

First, random/omni-like beamforming vector scanning is considered. This is illustrated later in respect of FIG. 12, which shows a possible example of random/omni-like beamforming vector scanning generated using Zadoff-chu sequence/weights to antenna elements.

Beamforming, or spatial filtering, is a signal processing technique used in sensor arrays for directional signal transmission or reception This is achieved by combining elements in an antenna array in such a way that signals at particular angles experience constructive interference while others experience destructive interference. Beamforming can be used at both the transmitting and receiving ends in order to achieve spatial selectivity. In other words, Beamforming is a method used to create the radiation pattern of at least one array antenna by adding constructively the weights of the signals in the direction(s) of at least one signal of interest and nulling the pattern in the direction(s) of signals not of interest (e.g. interference).

When compared to the exhaustive search scanning used by currently employed positioning techniques, the following may provide local soft estimate of the positioning parameters that are configured and obtained using sparse measurements. This may be performed, for example, by projecting the radio channel used for measurements onto a lower dimension subspace via standard compressed scanning approach using non-directional beamforming in random directions.

Thus, each gNB/access point may independently obtain coarse estimates of the positioning parameters by using ‘omni-type or omni-like’ beamforming vectors. For example, in one non-limiting example, the gNB may use shifted (e.g. randomly shifted, or shifted using a configured value) Zadoff-chu sequences to generate the beamforming vectors, where the shift is determined relative to a designated value in the sequence being shifted. These coarse estimates may also be referred to as “soft information”. The coarse estimates may comprise a range of values and/or a discrete set of values and/or as a probability distribution. As an example, omnidirectional beamforming may mean that the radiation pattern of the transmitting antenna (or transmitting antennas) is equally strong in each direction. Omni-type beamforming may be described as a radiation pattern that radiates power to multiple directions in omnidirectional or almost in omnidirectional fashion. This omni-type radiation pattern may refer to the use of a sparse receive beamforming codebook to perform (coarse) measurements on the channel. The beamforming codebook may be generated by using at least one designated sequence (such as Zadoff-chu or the like). The beamforming codebook may comprise of one or more entries e.g. beamforming antenna patterns. An index may be associated with each of the antenna patterns (or parameters used for generating the antenna patterns. An index may be used to refer to specific entry in the codebook (or the set of antenna patterns or parameter(s) used for generating the beamforming antenna patterns. In one example, or omni-type/like beamforming/radiation pattern, there may or may not be any clear main lobe/lobes or side lobe(s) in the radiation pattern. Such a radiation pattern and/or beamforming may be referred as “non-directional”. This is illustrated later (e.g. in FIG. 12).

Second, this obtained soft information on positioning parameters may be exchanged between the access points making the positioning measurements and/or from the access points to a Location Management Function (LMF) (or an equivalent positioning entity in the core network).

Under this proposal, each gNB/access point independently computes soft information on positioning parameters from the acquired channel measurements (e.g., time-, angle-, and phase-related channel measurements) and stores them in local storage memory. Potentially each gNB involved in providing positioning information for determining the location of a UE may perform this process.

The use of soft information for obtaining the positioning of a particular UE may be configured in a participating gNB/access point in a number of ways. For example, whether the gNB/access point accumulates information can be explicitly indicated and/or triggered by the core network using a new extension to an existing signalling protocol (e.g. as an extension to New Radio Positioning Protocol A (NRPPa) Management Procedures). As another example, the use of such a procedure can be autonomously implemented by the gNB/access point without any network assistance.

In one possible implementation, a probability function may be generated that models the likelihood for the positioning parameters (e.g., angles, time and phase) from the independently acquired measurements by each gNB. Subsequently, quantized soft information on the positioning parameters may exchanged among at least two coordinating gNBs obtaining the positioning measurements and/or provided to a central unit (e.g., LMF) for localization.

Third, geometry-aided positioning is considered. Under this process, the position of the target UE is obtained by using a known geometric distribution of the gNBs/access points making the positioning measurements in combination with the soft measurements to obtain a more accurate position for the target UE. This may be performed in either in a centralized or distributed manner.

For example, by exchanging geometry-aided soft information among coordinating gNBs, the dependencies between local estimations at each gNB can be efficiently exploited/leveraged. By using quantized geometric factors (e.g., network disposition, gNBs' location, orientation, etc.), unfeasible estimates of the positioning parameters may be eliminated. The quantized soft information on the positioning parameters may be exchanged among coordinating gNBs and/or provided to a central unit (such as the LMF), which can further improve the positioning accuracy (e.g., by merging the assisted information on network disposition with the relative local measurements of gNB).

Due to the sparse omni-type scanning performed in the presently described the access links, any unused Positioning Reference Signal (PRS) and/or Sounding Reference Signal (SRS) resources can be made available for other UEs and/or optimized to reduce interference between the signals. Furthermore, sparse scanning provides clear advantages in terms of latency and overhead on access links. Finally, the procedure of combining the acquired measurements with the geometry-aided soft information exchange allows to efficiently cope with the unavailability of at least one dominant link (e.g. a LOS link or, more generally, a link that can be considered as a strongest link). This may assist in providing robustness against link blockage, as verified in the provided numerical examples provided below.

The proposed method may significantly reduce the scanning overhead in access links through non-directional ‘omni-type’ beam training vectors while the achievable positioning accuracy is comparable to state-of-art approaches for other types of signals, even in the presence of random blockage of the link used for positioning measurements and any deep fading channel conditions.

To aid in understanding the following examples, some mathematical background for channel measurements and corresponding soft information is provided. To simplify the explanation, it is assumed that K single antenna UEs are coherently served by B gNBs, each of the B gNBs having N receive antenna elements. Let h_{b.k} be the channel between an arbitrary gNB-UE pair (b, k). Further, to simplify the illustration and MATLAB implementations, the following is restricted to an angle-based positioning approach. However, the principles underlying the present proposals may be extended to other measurement metrics by the person skilled in the related art.

Geometrical factors that are being exploited in the present disclosure will be considered using a first example model. It is understood that this is merely an example, and that other configurations and assumptions may be made while still applying the presently described principles.

Under a perfect synchronization assumption, the channel measurement at the b-th gNB is given by

$${y}_{b} [ m ] = {w}_{b}^{H} [ m ] {h}_{b , k} {t}_{k} [ m ] + {v}_{b} [ m ] , \qquad ( 1 )$$

where tₖ[m] is the known pilot transmitted by k-th UE in the m-th training slot (or channel measurement). Notation w_{b}[m] represents the receive beamforming vector at b-th gNB, while the circularly symmetric Additive white Gaussian noise (AWGN) is represented as v_{b}[m]˜CN(0,σ²).

To simplify the exposition, a local Angle of Arrival (AoA) θ_{b,k} estimation at each gNB is used. By considering the local AoA, under the far-field assumption, the radio channel h_{b.k} may be approximated as:

$${h}_{b , k} = {α}_{b , k} a ( {θ}_{b , k} ) , \qquad ( 2 )$$

where α_{b,k} is an unknown complex gain (and may comprise including potential NLOS effects), and a(θ_{b,k}) is an array steering vector for the angle θ_{b,k}. Thus, based on these considerations, channel measurement defined by (1) may be equivalently rewritten as

$${y}_{b} [ m ] = {α}_{b , k} {w}_{b}^{H} [ m ] a ( {θ}_{b , k} ) {t}_{k} [ m ] + {v}_{b} [ m ] . \qquad ( 3 )$$

This may be compactly written in vector form using the following notation. Let y_{b}∈C^{M×1} be the collection of M<<N projections of a(θ_{b,k}) that are obtained by using different receive beamforming vectors {w_{b}^{H}[m]}ₘ₌₁^{M} at a gNB, where “M” represents a number of accumulated measurements at each gNB. Further, define a projection matrix A_{b}∈C^{M×N} with A_{b}(m,:)=w_{b}[m]. Thus, the above expression can be compactly rewritten in vector form as

$${y}_{b} = {α}_{b , k} {A}_{b} a ( {θ}_{b , k} ) + {v}_{b} .$$

Next, the likelihood function p(y_{b}|θ_{b,k}), which defines a probability of receiving a signal (y_{b}) at an AoA (θ_{b,k}), is defined:

$$p ( {y}_{b} \vert {θ}_{b , k} ) = exp ( {\vert {y}_{b} - \frac{{( {A}_{b} a ( {θ}_{b , k} ) )}^{H} {y}_{b} ( {A}_{b} a ( {θ}_{b , k} ) )}{( {A}_{b} a ( {θ}_{b , k} ) )} \vert}^{2} / {σ}^{2} ) , \qquad ( 4 )$$

where

$${α}_{b , k} = \frac{{( {A}_{b} a ( {θ}_{b , k} ) )}^{H} {y}_{b}}{( {A}_{b} a ( {θ}_{b , k} ) )} ,$$

and may be obtained by using standard optimization techniques.

In general, expression (4) describes the joint probability (e.g., probabilistic prediction) of the observed measurement as a function of a positioning parameter, which is the angle of arrival in the present example. It is understood that this probability may be expressed using an alternative positioning parameter where alternative positioning parameters are determined.

The overall goal is to find the values of the model parameter (e.g., AoA) that maximize the likelihood function over the parameter space independently at each gNB. This may be expressed as:

$${\hat{θ}}_{b , k} = arg {max}_{{θ}_{b , k} ∈ Θ} p ( {y}_{b} \vert {θ}_{b , k} ) ,$$

where the parameter space Θ can be a discrete and/or quantized searching space.

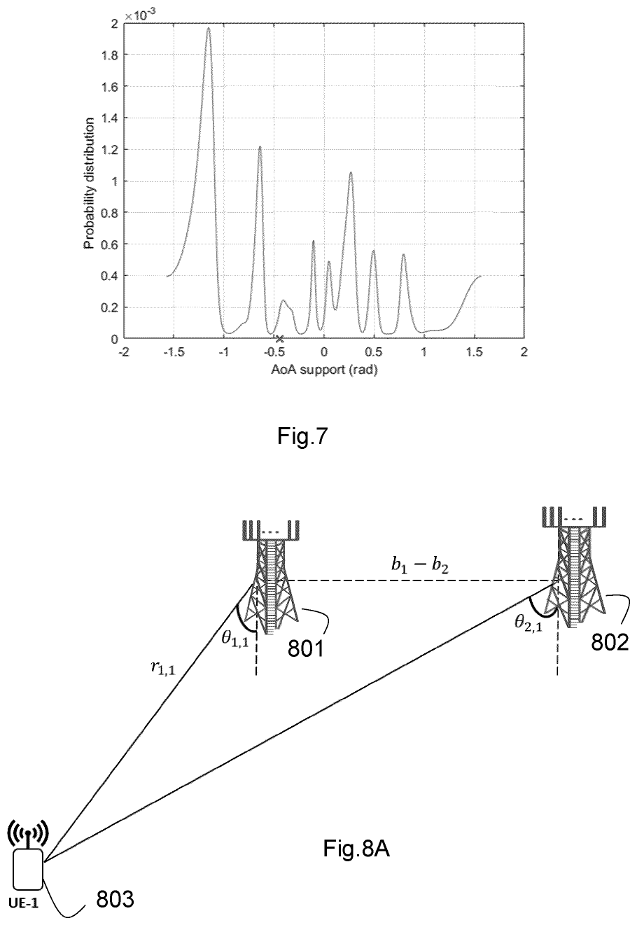

This mathematical model is illustrated through the following example. In this example, it is assumed that the parameter space Θ∈[−90°, 90°] with a quantized grid of 1440 steps between these two angles. Using a test MATLAB implementation, a likelihood distribution of the AoA between a UE-gNB pair is obtained, and shown in FIG. 7, which shows a plot of the probability distribution against an AoA at a gNB.

From the example of FIG. 7, it can be concluded that locally acquired soft information can be very noisy due to having sparse random measurements on the access links. However, by using the presently described geometry-aided cooperative post-processing techniques, a more accurate position of UE may be efficiently recovered, as it will become clear in the numerical simulation section.

The following illustrates some of the geometric factors being considered for exploiting in the present disclosure.

To simplify the example, the following is illustrated using 2D positioning and LoS conditions. However, it is understood that the underlying geometric dependencies are generic and can be extended to other cases (e.g., NLOS, 3D, also including gNB and UE rotations).

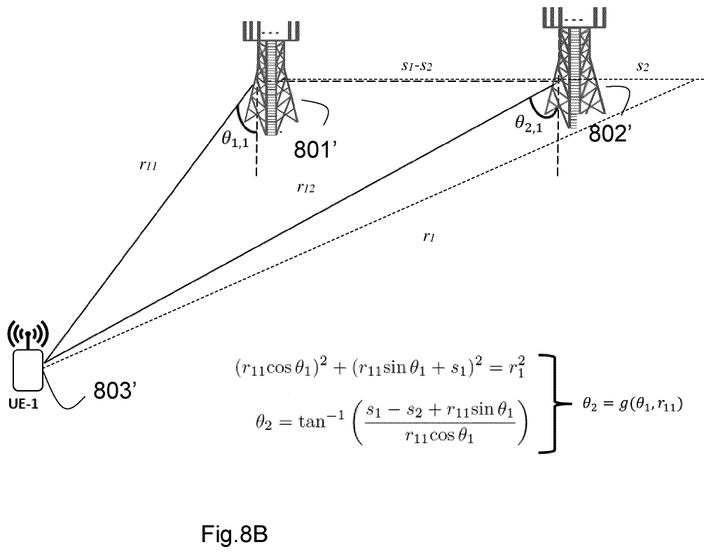

In the following, the dependencies among local AoAs of different coordinating gNBs are considered with reference to FIG. 8.

FIG. 8A shows a first gNB 801 (gNB-1) separated from a second gNB 802 (gNB-2) by a distance of b₁-b₂. The first gNB 801 is located at a distance of r_{1,1} from a UE 803 (UE-1) whose position is to be determined. As can be seen in FIG. 8A, a positioning signal signalled between UE 803 and the first gNB 801 is indicated as having an AoA of θ_{1,1} while a positioning signal signalled between UE 803 and the second gNB 802 is indicated as having an AoA of θ_{2,1}.

The angle at gNB-2 (θ_{2,1}) is the function of parameters at gNB-1 (e.g., r_{1,1}, θ_{1,1}) and known geometric disposition of the network, and is given by:

$${θ}_{2 , 1} = {tan}^{- 1} ( \frac{{b}_{1} - {b}_{2} + {r}_{1 , 1} sin {θ}_{1 , 1}}{{r}_{1 , 1} cos {θ}_{1 , 1}} ) . \qquad ( 5 )$$

For the example of FIG. 8A, this equation (5) can easily be obtained by using Side-Angle-Side (SAS) triangle rules. Similar side information, i.e., geometric factors assuming other gNB-UE dispositions than that depicted in FIG. 8A, may be obtained using similar geometric formulae. For example, the example of FIG. 8B, which uses similar labelling to that of FIG. 8A bar the entities are indicated with a prime mark, illustrates additional geometric considerations that may be applied when determining the known geometric dispositioning of the network to calculate UE positioning.

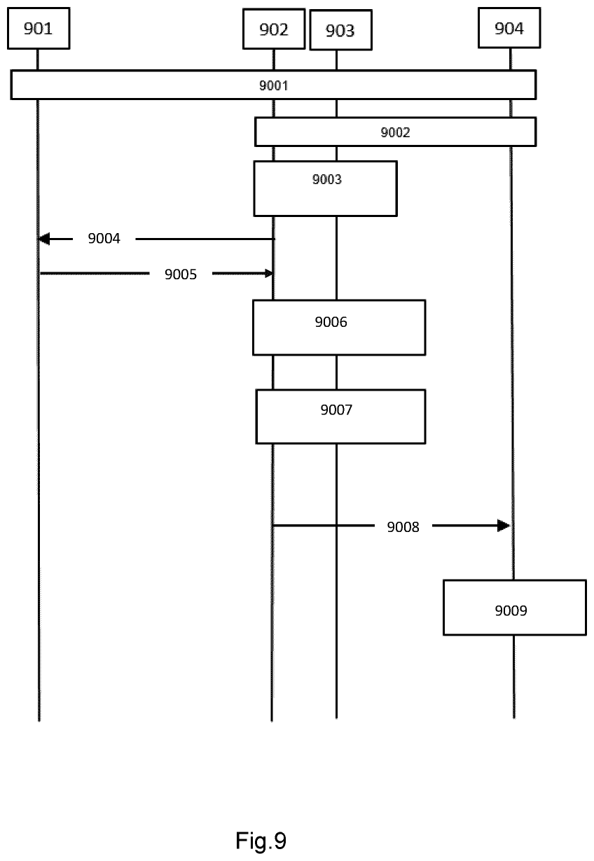

FIG. 9 illustrates example signalling between a UE 901 whose position is to be determined, a first gNB 902, a second gNB 903, and an LMF 904. It is assumed that the UE 901 is configured with at least one orthogonal (and known) pilot sequence for uplink sounding signal transmissions prior to this signalling being performed. These pilot sequence(s) may be orthogonal to each other.

At 9001, the UE 901, first gNB 902, second gNB 903 and LMF 904 exchange reference signal and measurement as well as measurement configuration information. Information exchange between LMF and gNBs can be done e.g. via at least one of NR positioning protocol A (NRPPa) and/or NR LTE Positioning Protocol (LPP). During this step, the network may, for example, configure the first and second gNB and/or the UE with at least one beamforming codebook, parameter control/selection metrics, and reporting mechanism, i.e., according to a predefined set of criteria, conditions, and reporting ways (e.g., based on UE service requirements, UE velocity, UE direction of movement, and higher-layer indications).

At 9002, the first gNB 902, second gNB 903 and the LMF 904 exchange an uplink resource configuration (e.g. sequence initialization information (e.g. sequence length, root sequence ID, sequence group ID) for a sequence (such as a Zadoff-Chu sequence) used for UL SRS and time-frequency resource information (e.g. a number of physical resource blocks (PRB) s, a density in frequency (e.g. every 2^{nd} or 4^{th} or 8^{th} resource element in PRB))) and measurement information, as well as measurement configuration information. In other words, the first and/or second gNBs may exchange uplink resource configuration, measurement configuration, and/or reporting configuration information with the LMF 904. In general, the exchanged resource configuration may refer to UE uplink transmission resources and the exchanged measurement configuration may refer to UL resources that are to be measured at gNBs. Moreover, the exchanged reporting configuration may refer to reporting configuration for reporting measurement information (e.g. the soft positioning information) from at least one gNB to at least one LMF.

At 9003, the first and second gNBs determine what resources are available for uplink (UL) sounding reference signals (SRS).

At 9004, the first gNB 902 signals a configuration of the determined UL SRS type resources to the UE 901. The UE 901, on receiving this configuration, uses the configuration to use pilot resources indicated for use in the configuration. In other words, the configuration may be seen as a triggering the UE to use those pilot resources indicated in the configuration.

Subsequent to the configuration of 9004 being applied by the UE 901, the UE may transmit the configured uplink SRS periodically and/or aperiodically (e.g. during 9005), where each orthogonal pilot symbol and/or SRS resource is assigned to a unique index and transmitted in the preconfigured uplink sounding interval. Meanwhile, during 9006, each coordinating gNBs independently implements a sparse receive beamforming codebook to collect coarse measurements on the channel (see Eq. (3) for details).

In other words, during 9006, each of the first and second gNBs independently perform measurements on received uplink SRS received from the UE 901. The uplink SRS transmissions may be made during 9005 responsive to the configuration of 9004 being employed by the UE 901. Specifically in the present example, during 9006, each gNB can independently collect coarse estimates of positioning parameters by using random ‘omni-type’ beamforming vectors, in at least one uplink training phase (and may be collected in each uplink training phase). As an example, the “shifted random Zadoff-chu sequences” may be good beamforming-generator candidates, and are already supported in current Release 16.

At 9007, each of the first and second gNBs independently generate soft-information (e.g. a distribution of positioning parameters) for locating the UE 901. As an aside, it is noted that the present techniques may be applied when there are multiple UE's in the communication system. In such a case, the soft information for locating the UE 901 may be made for each UE whose position is being determined. Further, where sidelink communications are configured between a set of at least two UEs, the set of UEs comprising the UE whose position is being determined, at least one of the other UEs in the set of UEs may generate at least part of this soft information. Therefore, it is understood that although the present (and later) examples discuss the generation of soft information in terms of gNBs, that at least some of this soft information may be generated by at least one UE in sidelink communications with the UE whose position is being determined (e.g. the first and/or second gNB may be a UE). One or more of the sidelink UEs may provide the soft information to a location function (e.g. LMF, Location Management Function) via LPP (LTE Positioning Protocol, a protocol used for positioning related communication between UE and LMF) protocol or via some other protocol used for communicating positioning related information (parameters, configuration, soft information etc.) between UE and a location management function.

Consequently, instead of the hard decision on the UE location made in prior systems, each gNB independently computes the soft information on positioning parameters (e.g., distribution and/or likelihood function, see equation (4) for details) from the acquired measurements and stores them in its local storage memory.

In one possible implementation, each gNB performing the soft information gathering instead of the hard decision process may be triggered/configured to perform in this way following signalling by the core network using New Radio Positioning Protocol A (NRPPa) Management Procedures. In another possible implementation, each gNB performing the soft information gathering instead of the hard decision process may be autonomously implemented by the gNB without any network assistance, configuration, and/or triggering.

At 9008, the first gNB 902 signals the LMF 904. This signalling of 9008 may provide quantized soft information and/or parameters for generating a distribution of localization parameters that were generated during 9007.

In a specific example, the accumulated soft information from 9007 is provided to network/LMF via the enhanced NRRPa protocol (e.g., NRPPa Location Information Transfer Procedures).

As one example, the soft information can be first projected onto lower dimension by using, e.g., mixed Gaussian mixture models, and the quantized mean and variance which are provided at network/LMF can be used to reconstruct the approximated soft information of each coordinating gNB.

At 9007, the LMF performs a position estimation of the UE 901 using the information provided during 9006.

For example, by merging the available side-information on the disposition of network elements (see Eq. (5) for details) with the relative local soft information on positioning parameters of each gNB, the LMF 904 can accurately localize the target UE.

The LMF 905 may use determined dependencies between local estimation at each of the first and second gNBs, known geometric disposition of coordinating gNBs (e.g., the first and second gNBs), and geometry-aided soft information exchange, to preemptively eliminate the infeasible parameter space from the distribution functions, and then reconstruct UE locations.

Once the position has been made, this may be provided to a positioning server and/or positioning client (not shown).

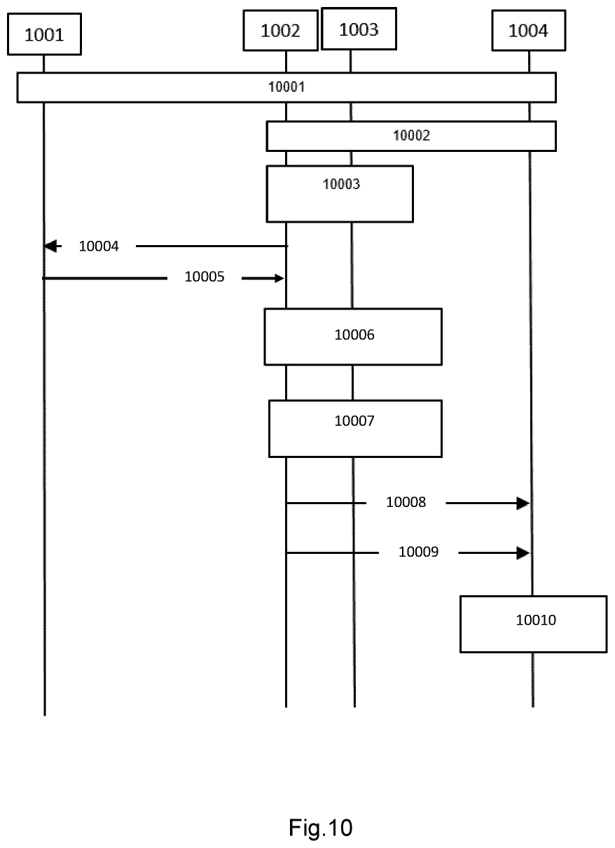

FIG. 10 provides another example signalling between a UE 1001 whose position is to be determined, a first gNB 1002, a second gNB 1003, and an LMF 1004. It is assumed that the UE 1001 is configured with at least one orthogonal (and known) pilot sequence for uplink sounding signal transmissions prior to this signalling being performed. These pilot sequence(s) may be orthogonal to each other.

At 10001, the UE 1001, first gNB 1002, second gNB 1003 and LMF 1004 exchange reference signal configuration and information. During this step, the network may, for example, configure the first and second gNB and/or the UE to change beamforming codebook, parameter control/selection metrics, and reporting mechanism, i.e., according to a predefined set of criteria, conditions, and reporting ways (e.g., based on UE service requirements, UE velocity, UE direction of movement, and higher-layer indications). Additionally, the network also configures and informs the root sequences required to generate the sparse non-directional beamforming codebook at each gNB.

At 10002, the first gNB 1002, second gNB 1003 and LMF 1004 exchange a resource configuration, and/or a measurement configuration, and/or a reporting configuration. These may be as described above in relation to 9002.

As an example, such a beamforming codebook can be obtained (or constructed) by applying (random) circular shift to, e.g., Zadoff-Chu sequences. Note that, when compared with standard Discrete Fourier transform (DFT) beamforming vectors, the Zadoff-chu based non-directional and coarse scanning provides better estimates on positioning parameters due to good auto- and cross-correlation properties. Thus, in general, the coarse scanning in the spatially separated directions might lead to better positioning accuracy due to uncorrelated information.

At 10003, the first and second gNBs determine what resources are available for uplink sounding reference signals (SRS).

At 10004, the first gNB 1002 signals a configuration of the determined UL SRS type resources to the UE 1001. The UE 1001, on receiving this configuration, uses the configuration to use pilot resources indicated for use in the configuration. In other words, the configuration may be seen as a triggering the UE to use those pilot resources indicated in the configuration.

Subsequent to the configuration of 10004 being applied by the UE 1001, the UE may transmit the configured uplink SRS periodically and/or aperiodically during 10005, where each orthogonal pilot symbol and/or SRS resource is assigned to a unique index and transmitted in the preconfigured uplink sounding interval. Meanwhile, during 10006, each coordinating gNBs may independently implement a sparse receive beamforming codebook (i.e. a receive beamforming codebook for sparse channels) to collect coarse measurements on the channel (see Eq. (3) for details).

In other words, during 10006, each of the first and second gNBs independently perform measurements on received uplink SRS received from the UE 1001. The uplink SRS transmissions may be made responsive to the configuration of 10004 being employed by the UE 1001. Specifically in the present example, during 10005 and 10006, each coordinating gNBs independently implements the sparse non-directional receive beamforming vector from the codebook to obtain the coarse/soft measurements on the channel (see Eq. (3) for details).

At 10007, each of the first and second gNBs independently generate soft-information (e.g. a distribution of positioning parameters) for locating the UE 1001. As an aside, it is noted that the present techniques may be applied when there are multiple UE's in the communication system. In such a case, the soft information for locating the UE 1001 may be made for each UE whose position is being determined.

Consequently, instead of the hard decision on the UE location made in prior systems, each gNB independently computes the soft information on positioning parameters (e.g., distribution and/or likelihood function, see equation (4) for details) from the acquired measurements and stores them in its local storage memory.

Each gNB may also inform the index of circular shift of the employed receive beamforming vectors with respect to configured root sequence, to LMF 1004 via enhanced NRRPa protocol.

In one possible implementation, each gNB performing the soft information gathering instead of the hard decision process may be triggered/configured to perform in this way following signalling by the core network using New Radio Positioning Protocol A (NRPPa) Management Procedures. In another possible implementation, each gNB performing the soft information gathering instead of the hard decision process may be autonomously implemented by the gNB without any network assistance, configuration, and/or triggering for the soft information gathering to be performed in place of a hard information/decision process.

At 10008, the first gNB 1002 provides a quantized offset to the LMF 1004. This offset is provided relative to a configured value in a root beamforming sequence. A generated sequence that has not been shifted is known as a root sequence. In other words, a first root sequence is generated, and then shifted random sequences may be generated from that root sequence using a predetermined algorithm. As a particular example, one such root beamforming sequence can be obtained by using the Zadoff-Chu sequences, which exhibit the useful property that cyclically shifted versions of themselves on provided offsets are orthogonal to one another.

At 10009, the first gNB 1002 provides at least one local measurement report to the LMF 1004.

At 10010, LMF 1004 performs offset corrections and estimates the position of UE 1001 using at least the information provided in 10008 and 10009. The LMF 1004 may, in the present example, compute the soft information on positioning parameters (e.g., distribution and/or likelihood function, see Eq. (4) for details) from the acquired measurements y_band informed receive beamforming codebook A_b of each gNB, and store them in local storage memory.

Thereby, in the present example, the LMF 1004 may merge the available assisted information on network disposition (see Eq. (5)) with the relative local measurement on positioning parameters of each gNB, the target UE can be accurately localized by the network.

The LMF may use determined dependencies between local estimation at each of the first and second gNBs, known geometric dispositions of the coordinating first and second gNBs, and geometry-aided soft information exchange, to preemptively eliminate any infeasible parameter space from the distribution functions (i.e. they are eliminated prior to a position for the target UE being determined), and then reconstruct a UE location for the UE 1001.

The position of the target UE (e.g. UE 901 and/or UE 1001) can be estimated as in the above examples in a number of ways. Some of these ways are illustrated below. However, it is understood that these are not limiting, as the exact information provided will inform the skilled person of the missing information to be calculated/determined and the most appropriate mechanism for performing that. The selected location determination calculation to be used may be selected in dependence on the types of available measurements and/or latency constraints.

As a first example, the first and second gNBs may autonomously exchange their local soft information on positioning parameters. This may be performed using, for example, an enhanced Xn interface, where an Xn interface is a direct interface between two gNBs. This exchange may result in improved soft information, which is then provided to LMF via enhanced NRRPa protocol to determine a location for the UE.

As a second example, the first and second gNBs may preemptively restrict their search space by using previously acquired measurements. By restricting their search space, an apparatus may limit the directions in which they scan and/or the timings at which they perform a scan. For example, when there are four soundings with a UE, the first sound may be random, and the second (and sequential) soundings may be improved from the report of the first sounding by restricting the search space for the UE. In other words, the gNBs may perform online/adaptive learning, and/or base current measurements on previously made local measurement. Specifically, a gNB may exploit a previously available measurement y_{b}[m−1] to improve a receive beamforming vector w_{b}[m] for the next training phase. This can be very useful when the UE whose location is being determined is stationary and/or is moving in certain directions. An efficient and proactive adaptive design of codebook can provide less correlated information at a gNB, which eventually leads to a better position accuracy of UE. In the present case, information is more likely to be correlated if it is obtained from scanning the same or similar location. Consequently, the correlation of the information may be reduced by increasing the diversity of the directions in which the scan is performed.

In a third example, the network/LMF may as part of an initial configuration step, pre-emptively configure a plurality of root sequences at the first gNB and/or the second gNB, and the UE. This configuration may be based on, for example, a physical-layer measurement performed during the initial access procedure and/or during communications between the UE and the gNB being configured (e.g. when UE is in connected mode), and/or available statistical information on the gNB-UE link between the UE and the gNB being configured. As an example, the gNB may utilize a beam-domain downlink Reference Signal Received Power (RSRP: The RSRP is a measurement of the received power level in a cell network. The average power is a measurement of the power received from a single reference signal) and/or a time-delay profile and/or other available measurements obtained during the initial access, and then determines the UE-specific SRS resource sets. Furthermore, the gNB may configure control and/or selection metrics that are to be used by the gNB to autonomously select a receive beamforming codebook from the available options for receiving the positioning signals.

The following considers a numerical example of the results that may be obtained using at least one of the presently described techniques. It is understood that this example is merely provided to illustrate the presently described principles, and that these principles also apply to multi-antenna and/or multi-user scenarios.

In this example, a single-antenna UE is coherently served by four gNBs (i.e. B=4), and each of these four gNBs is equipped with a uniform linear array (ULA) of N=16 antennas elements. Further, the four gNBs are placed in a 50×50 metres square layout (resembling, e.g., a factory-type setup) and connected to a common baseband unit (BBU) in the edge cloud. The UE's maximum uplink transmit power is set to P, where P=23 dBm. Further, the AWGN noise is set to −174 dBm/Hz, while transmit carrier-frequency f is set to 28 GHz, and a 100 MHz frequency band is assumed to be fully reused across all four of the coordinating gNBs. The radio channel h_{b,k} between a Remote Radio Unit (RRU)-UE pair is based on a sparse geometric model, which is widely adopted in studies related to mmWave signal processing. Specifically, the radio channel between a UE-gNB pair (b, k) is defined as

$${h}_{b , k} = \sqrt{\frac{N}{P}} [ {\sum }_{p = 1}^{P} {v}_{b , k}^{p} {d}_{b , k}^{- {ρ}_{p}} α ( {θ}_{b , k}^{p} ) ]$$

where v_{b,k}^{p} is random complex gain, d_{b,k}^{-ρ}^{ₚ} is the distance between gNB-UE pair with path loss exponent ρₚ∈[2,6]. Finally, α(θ_{b,k}^{p}) denotes the array steering vector for the ULA for AoA θ_{b,k}^{p}, which is based on network disposition. The results are averaged over 1000 random channel realizations.

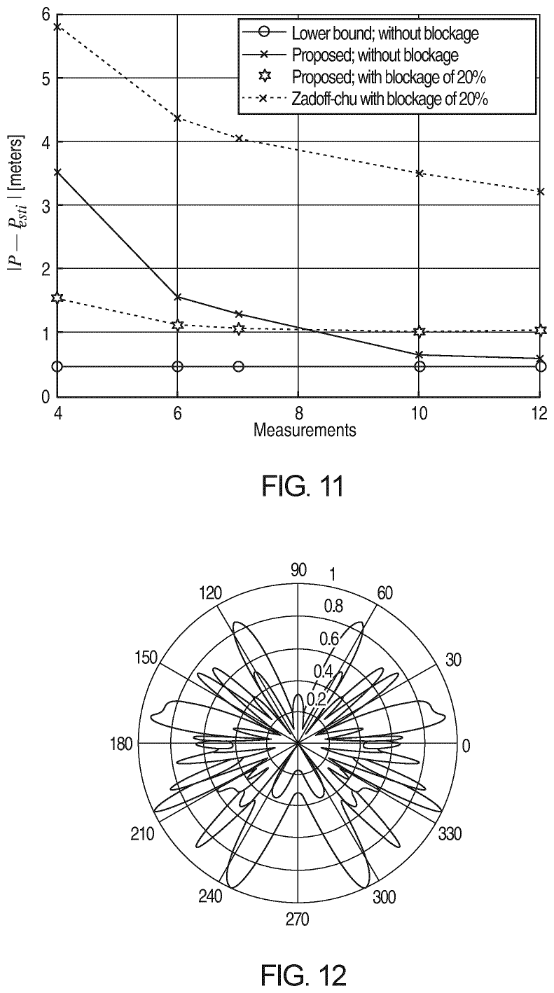

FIG. 11 illustrates different plots of the obtained positioning error (|P−Pₑₛₜᵢ|) against the number of measurements (i.e. so that more measurements generally results in more accurate positioning).

In FIG. 11, the bottom line corresponds to exhaustive beam scanning without any blockage of positioning signals between the gNBs and the UE whose location is being determined. This considers a standard discrete fourier transform ((DFT) based received beamforming codebook, and measurement y_{b}∈C^{16×1} that are obtained by exhaustively scanning all codebook |W|=16|.

The adjacent line to this bottom line corresponds to the proposed system without any blockage, and the line above this adjacent line corresponds to the proposed system, but with a blockage of 20% of the positioning signals. The topmost line corresponds to Zadoff-Chu signalling with a blockage of 20% of the positioning signals.

FIG. 11 thus illustrates that the presently proposed method may achieve comparable performance with the baseline method with fewer random measurements than is performed in the base line method. Moreover, in the presence of random link blockage (˜20% blockage), the proposed soft local estimate on positioning parameters based on fewer random measurements in the access links, followed by geometry-aided educated guess on UE location achieves a superior performance, and is comparable with the lower bound of the DFT method. It is understood that a similar performance trend may be obtained with different parameter settings and network configurations.

FIG. 12 illustrates beamforming pattern of shifted Zadoff-chu sequences for ULA with N=16 antennas. In this example, an omni-type beamforming pattern is generated from two randomly shifted Zadoff-chu sequences.

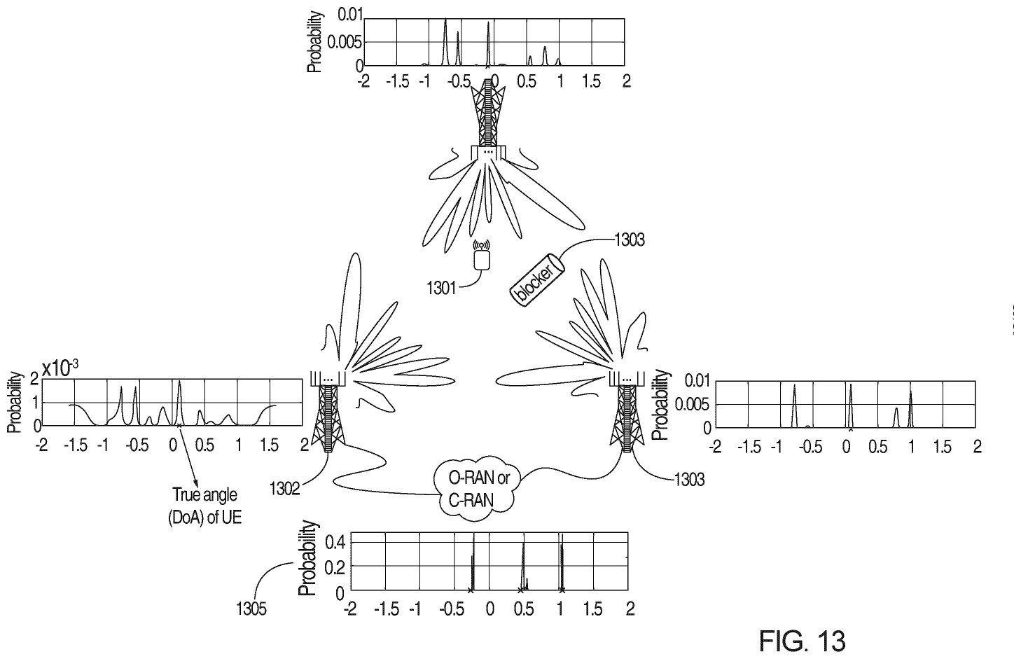

FIG. 13 illustrates the proposed coarse non-directional scanning in the access network and parameterized soft information exchange in backhaul/fronthaul links of positioning parameters.

In particular, FIG. 13 shows a determined angle of arrival (in radians) relative to the probability of that angle of arrival for each of a UE 1301 whose position is being determined, a first gNB 1302, and a second gNB 1303. A blocker 1304 is shown as blocking at least some direct transmissions between the second gNB 1303 and the UE 1301, which leads to a noisier and more erroneous local angle estimation at the second gNB 1303 than is made at the first gNB 1302, which is unaffected by a blocker. By exchanging information between the first and second gNBs 1302, 1303 and by using positioning information of the first and second gNBs 1302, 1303, unfeasible locations of the UE 1301 may be identified and ignored, as shown at 1305 in FIG. 13.

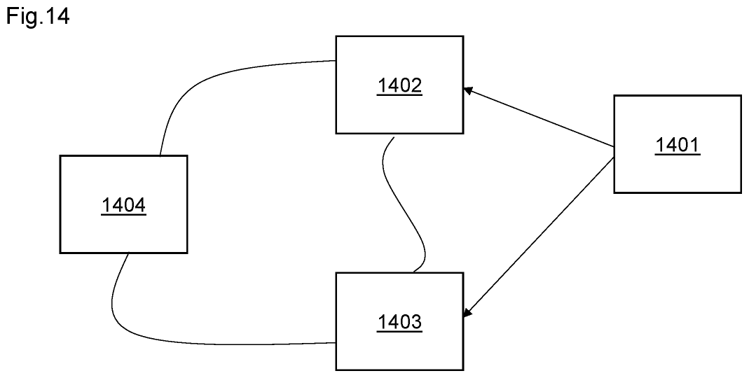

FIG. 14 illustrates apparatus that may perform elements of the presently proposed system for both of the examples of FIGS. 9 and 10.

FIG. 14 illustrates a UE 1401 whose position is to be determined, a first access point 1402 and a second access point 1403, each of the access points being configured to perform positioning-related measurements on positioning signals transmitted by the UE 1401, and a core network apparatus 1404, such as an LMF, for computing a position of the UE 1401 based on position information obtained by each of the first and second access points 1402, 1403.

The UE 1401 is configured by the core network apparatus with an orthogonal pilot and sounding reference signal resource sets for transmitting signals on which positioning measurements may be made by the access points 1402, 1403. The UE 1401 may transmit such positioning-related signals using the configured orthogonal pilot and at least one of the sounding reference signal resource sets. The orthogonal pilot signal may be configured to be orthogonal to other positioning signals to be transmitted by other UE during the same, or similar, time frames.

Each of the first and second access points 1402, 1403 may be configured with a root sequence (e.g. a root Zadoff-Chu sequence) or beamforming codebook for receiving and/or exchanging positioning-related signalling with the UE 1401. This configuring may be performed by an apparatus in the network (e.g.an LMF or a gNB, such as a coordinating gNB). In another example, the access points may determine and/or select a root sequence (e.g. a root Zadoff-Chu sequence) or beamforming codebook by themselves. In a further example, the access points may further provide the selected a root sequence (or the used cyclic shift of the root sequence) or beamforming codebook (a codebook may comprise of one or more beamforming patterns) to an apparatus in the network (e.g. an LMF or a coordinating gNB). Access points may in some examples provide indication of a selected sequence or selected identifier that was used for determining/deriving the beamforming pattern for one or more measurement(s).

Each of the first and second access points 1402, 1403 may be configured to (and perform) independent measurements of the positioning parameters to be determined for the UE 1401. In other words, the positioning measurements performed by the first access point 1402 may be performed independently of the positioning measurements performed by the second access point 1403.

Each of the first and second access points 1402, 1403 may independently generate soft positioning information, such as likelihood functions from acquired positioning parameters, ranges of values, sets of discrete values, etc. In other words, the positioning measurements performed by the first access point 1402 may be performed independently of the positioning measurements performed by the second access point 1403, and these positioning measurements may be represented in a “coarse” or “soft” form, such as at least one likelihood function, at least one range of values, and/or at least one set of discrete, non-contiguous values.

The first and second access points 1402, 1403 may be configured to exchange information with each other using a direct interface therebetween. For example, when the first and second access points are gNBs, this interface may be an Xn interface.

At least one of the first and second access points 1402, 1403 may provide their soft positioning information to the other of the first and second access points 1402, 1403. The access point receiving such soft positioning information may use the received soft positioning information to refine its own soft positioning information. For example, the receiving access point may use the received soft positioning information to eliminate potential locations of the UE from its own soft positioning information and/or to reduce a range of or eliminate at least one positioning parameter value to form a refined soft positioning information. This refined positioning information may be provided to the LMF 1404.

The refined positioning information may be further refined by at least one of the access points 1402, 1403 prior to provision to the LMF 1404 and/or by the LMF 1404 by utilising known locations of the access points participating in the measurement process and geometry for determining the location of the UE 1401 to eliminate potential locations of the UE from the refined information.

In one example, both the first and second access point 1402, 1403 provide their unrefined soft position estimates to the LMF 1404. In this case, the LMF 1404 may use all of the provided soft positioning information and the known positions of the first and second access points 1402, 1403 to determine a location of the UE 1401. The LMF may therefore be said to determine a position of the UE 1401 from a combination of the known geometry/locations of the first and second access points 1402, 1403, the beamforming codebooks, and local measurement reports of positioning parameters made by each of the first and second access points (i.e. each of the access points performing positioning-related measurements on positioning signals transmitted by the UE 1401 during at least one designated time interval).

The proposed system comprises a mechanism implemented by the network and a mechanism implemented by the gNB. These mechanisms may proactively exploit the mmWave channel sparsity and the flexible NR frame/slot structure. Assuming beam-domain processing at both the gNB and the UEs in NR Release 17 and beyond, features of the presently described system may comprise a dynamic indication mechanism for positioning purposes whereby the network preemptively indicates to the gNB and/or the UE to change beamforming codebook, parameter control/selection metrics, and reporting according to a predefined set of criteria, conditions, and reporting ways.

This dynamic indication mechanism may comprise an event-based triggering mechanism in which the gNB and/or the UE employs the sparse beamforming codebook for UL/DL positioning measurements in dependence on at least one parameter. For example, the sparse beamforming codebook may be determined in dependence on at least one of: UE service requirements, UE velocity, UE direction of movement, and network indications received from the core network.

There is further provided a signalling mechanism for gNBs that facilitates the signalling of soft information from the acquired UL/DL measurements on sounding resources, and a mechanism to locally store the acquired information in a storage memory. A reporting and information exchange mechanism of the accumulated local information among coordinating gNBs may be provided. This may be provided via an enhanced NG interface and NRPPa protocol. Such mechanisms may be based at the physical layer (e.g., Downlink Control Information (DCI)) and/or Medium Access Control (MAC) (e.g., MAC control element) and/or Radio Resource Control (RRC) level signaling.

There is further provided a centralized and/or distributed procedure to improve the accuracy of the position estimates by exploiting the disposition of the transceivers in the network deployment area with the acquired soft information on the positioning parameters via independent sparse measurements at at least one gNB performing a positioning-related mechanism.

In the above examples, the information provided to the LMF by a gNB that is part of the soft positioning estimation/coordinating set of gNBs may be provided such that each individual value pair (for example [AoA, probability]) of the soft information is provided

As another example, the information provided to the LMF by a gNB that is part of the soft positioning estimation/coordinating set of gNBs may be provided such that each of the coordinating gNBs may provide the angle value (degrees/radians) for the N highest probabilities observed in the generated soft information.

Alternatively or additionally to this another example, each provided angle value may be signaled with an absolute value of the probability associated probability value.

Alternatively or additionally to this another example, each provided angle value may be signaled with the relative value of the probability associated with the highest probability value (in the soft information).

Alternatively or additionally to this another example, each provided angle value may be signaled with the relative value of the probability associated with the configured (absolute) probability value. This value may be common for all soft information generated by the coordinating gNBs (TRPs). The provided angle values may use a probability value that is above a specific threshold value (e.g. configured by the LMF or another network entity) to identify those angles that are determined to be suitable for reporting to the LMF. In one example, the reporting gNB does not provide any value or value pair to the LMF that is not above the threshold, or provides only the angle value with the highest probability.

The angle value accuracy may be configured, e.g. nearest integer value (or the closest value within 0.1/0.01 degree of accuracy and so on) for the probability value provided.

The angle information may be quantized, such as applying the angular spread over a specific raster (i.e. set of/granularity of angle values for which information is provided) based on one or more parameters. In one example, a gNB may be configured to apply, for example 1 degree, 10 degree, or X degree raster for a particular signalled angle value. For the signalled angle value, a probability value (e.g., the highest/average probability) observed within the specific raster value points may be provided as part of the value pair provided to the LMF. This angle domain quantization may be configured by LMF. As an example, a signalled angle of 40 degrees may have a raster of 10 degrees, resulting in 4 different angle values (with associated probability value) being provided (i.e. ranges 0-10, 10-20, 20-30, 30-40) and so on. As another example, a signalled angle of 360 degrees may have a raster of 10 degrees, resulting in 36 different angle values (with associated probability value) being provided (i.e., ranges 0-10, 10-20, 20-30, 30-40).

Each of the coordinating gNBs in the set may be configured to perform measurements on beams generated according to specific values of cyclic shift of one or more sequences and/or according to specific values of one or more cyclic shifts of one or more sequences. A coordinating gNB/TRP may be configured to associate the provided soft information with the used sequence and/or cyclic shift (in case of using Zadoff-chu sequences or sequences with similar properties)

The LMF may provide at least one parameter.

The positioning information between a gNB and the LMF may be provided according to a defined protocol, such as via NRPPa.

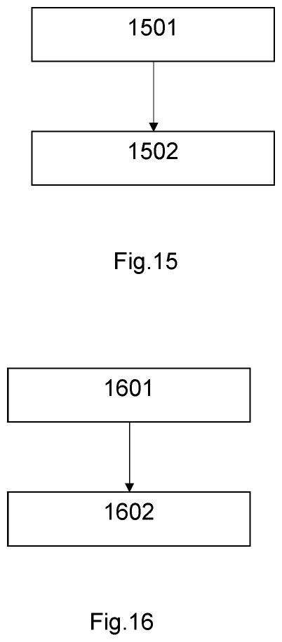

FIGS. 15 to 16 illustrate some of the operations that may be performed by at least one of the apparatuses described above. It is therefore understood that features of the above examples may also be implemented by the following described apparatus. It is further understood that the apparatus of FIGS. 15 and 16 may interact with each other.

FIG. 15 illustrates potential operations that may be performed by an apparatus for a first apparatus. The first apparatus may be an access point (e.g. a gNB or some other transmission-reception point). The first apparatus may be a user equipment engaged in sidelink communications with the first user equipment (described further below).

At 1501, the apparatus performs first positioning measurements using beamforming (e.g. reception beamforming) on transmissions made by a first user equipment, UE, to obtain first soft positioning information relating to the location of the first UE.

This soft positioning information may comprise at least one of a range of values, a set of values, and/or at least one probability distribution function related to at least one parameter for calculating a position of the first UE. The soft positioning information may provide a coarse estimate of a location of the first UE.

The beamforming may be performed on transmissions using, for example omni-type beamforming transmissions and/or received using omni-type reception configurations at the first apparatus.

At 1502, the apparatus provides the first soft positioning information to at least one of a second apparatus and/or a location function located in a core network. This location function may be the location function of FIG. 16.

The apparatus may receive second soft positioning information from the second apparatus. In such a case, the apparatus may generate the first soft positioning information by modifying soft positioning information derived independently by the first apparatus using said first positioning measurements using the second soft positioning information. In other words, the first soft information may represent a combination of soft positioning information independently obtained and/or generated by each of the first and second apparatus.

The apparatus may determine the relative locations of the first and/or second apparatus and generate first soft positioning information using said determined relative locations of the first and/or second apparatus. In particular, the apparatus may use the relative positioning of the first and second apparatus to eliminate potential locations of the first UE from the soft positioning information obtained by at least one of the first and second apparatus.

The apparatus may determine the relative locations of the first and/or second apparatus and provide the determined relative locations to the location function.

The apparatus may provide, to the location function, an indication of an identifier associated with a parameter vector for generating a beamforming pattern or patterns on which the first positioning measurements are based. The identifier may comprise an indication of a circular shift of a root sequence used for obtaining a codebook on which the first positioning measurements are based. For example, the apparatus may indicate a circular shift of a root sequence of a Zadoff-Chu sequence.

The apparatus may receive, from the location function, an instruction to obtain soft positioning measurements in respect of the first user equipment before said providing the first positioning measurements.

The apparatus may receive, from the location function and/or a coordinating access point, a configuration for obtaining the first positioning measurements.

FIG. 16 illustrates potential operations that may be performed by an apparatus for a location function.

At 1601, the apparatus receives, from a first apparatus, first soft positioning information relating to positioning measurements performed by said first apparatus, wherein the first soft positioning information relates to a location of a first user equipment, UE.

The first apparatus may be the apparatus described above in relation to FIG. 15.

This soft positioning information may comprise at least one of a range of values, a set of values, and/or at least one probability distribution function related to at least one parameter for calculating a position of the first UE. The soft positioning information may provide a coarse estimate of a location of the first UE.

At 1602, the apparatus determines the location of the first user equipment using a determined location of the first apparatus in combination with the first soft positioning information. The location determined at 1602 may be provided to a client requesting the location of the first UE from the location function.

The first soft positioning information may comprise second soft positioning information relating to positioning information measurements performed by a second access point.

The apparatus may receive, from a second apparatus, second soft positioning information relating to positioning measurements performed by said second apparatus, wherein the second soft positioning information relates to a location of a first user equipment. In this case, the first and second soft positioning information may respectively reflect independent positioning measurements performed by the first and second apparatus. Said determining the location of the first user equipment may be further performed using a determined location of the second apparatus in combination with the second soft positioning information. In other words, the apparatus may refine a coarse location position for a UE provided by the soft positioning information obtained independently by each of the first and second apparatus by using geometry and relative positioning of the apparatus to eliminate unfeasible locations from the coarse location position/soft positioning information. The apparatus may receive at least one of a location of the first apparatus and/or a location of the second apparatus.

The apparatus may receive, from the first apparatus, an indication of an identifier (or an index) associated with a parameter vector for generating a beamforming pattern or patterns on which the first positioning measurements are based. The identifier may comprise an indication of a circular shift of a root sequence used for obtaining a codebook on which the first positioning measurements are based. The identifier may comprise an index value referring to a beamforming antenna pattern (e.g. preconfigured antenna patterns in a codebook or in a set of antenna patterns). For example, the apparatus may indicate a circular shift of a root sequence of a Zadoff-Chu sequence.

The apparatus may signal, to the first apparatus equipment before said first positioning measurements are received, an instruction to obtain soft positioning measurements in respect of the first user.

The apparatus may signal, to the second apparatus equipment before said second positioning measurements are received, an instruction to obtain soft positioning measurements in respect of the first user.

The apparatus may transmit, to the first apparatus before the first positioning measurements are received, a configuration for obtaining the first positioning measurements.

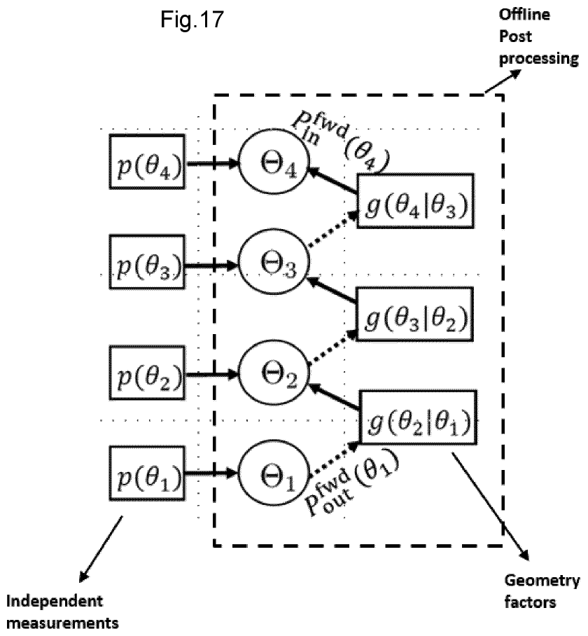

FIG. 17 provides a schematic overview of how the geometry (e.g. the relative location of at least two different apparatus making positioning measurements on a positioning signal transmitted by a UE) may affect the soft information derived from a plurality of independent positioning measurements collected by those at least two different apparatus. It is understood that although this FIG. 17 only shows independent measurements being input from a maximum of four separate apparatus making positioning measurement, that this is merely an example and that the present techniques are not limited to a maximum of four measuring apparatuses. Instead, there may be “B” apparatuses making independent positioning measurements on at least one positioning signal transmitted by a user equipment whose position is to be determined.

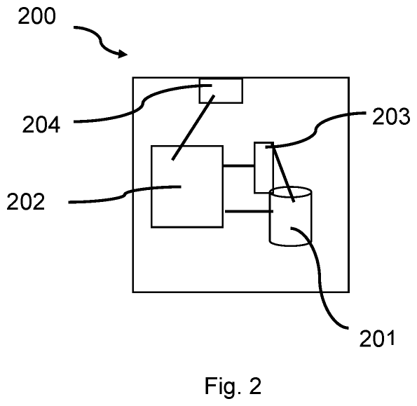

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

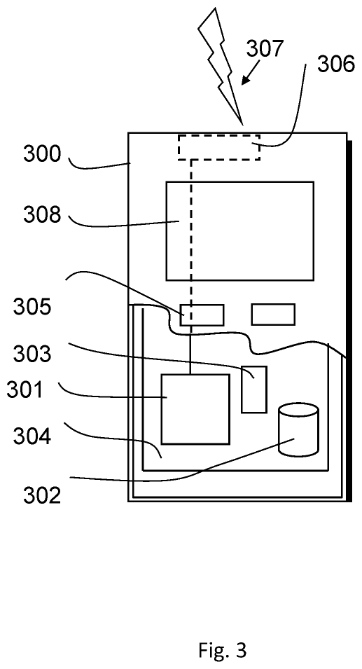

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or′ wireless) to other devices and/or for connecting external accessories, for example hands-free equipment, thereto.

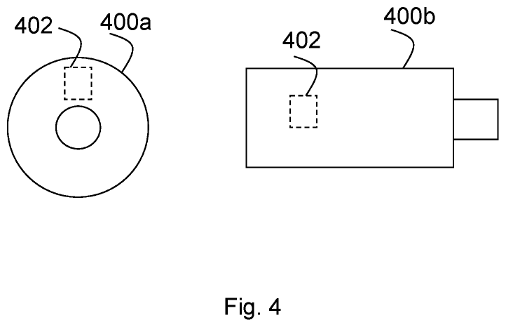

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 14 and/or FIG. 15.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 14 and/or FIG. 15, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally, some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

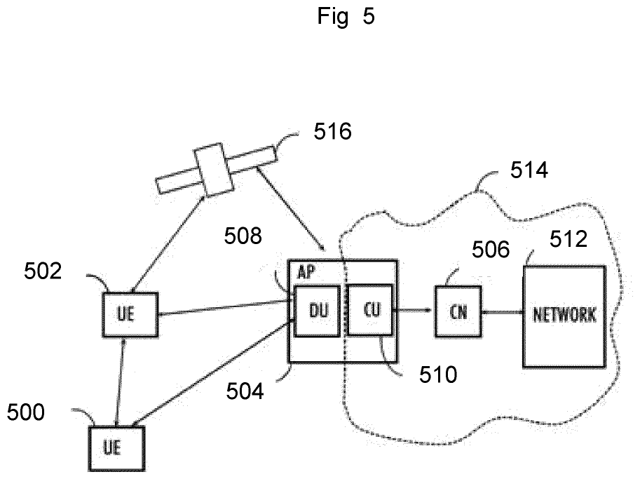

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 5). A HNB Gateway (HNB-GW), which is typically installed within an operator's network may aggregate traffic from a large number of HNBs back to a core network.

1-20. (canceled)

21. An apparatus as a first apparatus for communication, the apparatus comprising a computer program stored in a memory, wherein the computer program when executed by a processor, the apparatus is caused to:
perform first positioning measurements using beamforming on transmissions made by a first user equipment to obtain first soft positioning information relating to the location of the first user equipment; and
provide the first soft positioning information to at least one of a second apparatus and/or a location function located in a core network.

22. The apparatus as claimed in claim 21, wherein the computer program when executed by a processor, the apparatus is caused to:
receive second soft positioning information from the second apparatus; and
generate the first soft positioning information by modifying soft positioning information derived independently using said first positioning measurements using the second soft positioning information.

23. The apparatus as claimed in claim 22, wherein the computer program when executed by a processor, the apparatus is caused to:
determine the relative locations of the first and/or second apparatus; and
generate the first soft positioning information using said determined relative locations of the first and/or second apparatus.

24. The apparatus as claimed in claim 21, wherein the computer program when executed by a processor, the apparatus is caused to:
determine the relative locations of the first and/or second apparatus; and
provide the determined relative locations to the location function.

25. The apparatus as claimed in claim 21, wherein the computer program when executed by a processor, the apparatus is caused to:
provide, to the location function, an indication of an identifier associated with a parameter vector for generating a beamforming pattern or patterns on which the first positioning measurements are based.

26. The apparatus as claimed in claim 25, wherein the identifier comprises an identifier of a circular shift of a root sequence used for obtaining a codebook on which the first positioning measurements are based.

27. The apparatus as claimed in claim 21, wherein the computer program when executed by a processor, the apparatus is caused to:
receive, from the location function, an instruction to obtain soft positioning measurements in respect of the first user equipment before said providing the first positioning measurements.

28. The apparatus as claimed in claim 21, wherein the computer program when executed by a processor, the apparatus is caused to:
receive, from the location function and/or a coordinating access point, a configuration for obtaining the first positioning measurements.

29. An apparatus for a location function, the apparatus comprising a computer program stored in a memory, wherein the computer program when executed by a processor, the apparatus is caused to:
receive, from a first apparatus, first soft positioning information relating to positioning measurements performed by said first apparatus, wherein the first soft positioning information relates to a location of a first user equipment; and
determine the location of the first user equipment using a determined location of the first apparatus in combination with the first soft positioning information.

30. The apparatus as claimed in claim 29, wherein the first soft positioning information comprises second soft positioning information relating to positioning information measurements performed by a second apparatus.

31. The apparatus as claimed in claim 29, wherein the computer program when executed by a processor, the apparatus is caused to:
receive, from a second apparatus, second soft positioning information relating to positioning measurements performed by said second apparatus, wherein the second soft positioning information relates to a location of a first user equipment;
wherein said determining the location of the first user equipment is further performed using a determined location of the second apparatus in combination with the second soft positioning information.

32. The apparatus as claimed in claim 29, wherein the computer program when executed by a processor, the apparatus is caused to:
receive at least one of a location of the first apparatus and/or a location of the second apparatus.

33. The apparatus as claimed in claim 29, wherein the computer program when executed by a processor, the apparatus is caused to: receive, from the first apparatus, an indication of an identifier associated with a parameter vector for generating a beamforming pattern or patterns on which the first positioning measurements are based.

34. The apparatus as claimed in claim 29, wherein the computer program when executed by a processor, the apparatus is caused to:
signal, to the first apparatus equipment before said first positioning measurements are received, an instruction to obtain soft positioning measurements in respect of the first user.

35. The apparatus as claimed in claim 29, wherein the computer program when executed by a processor, the apparatus is caused to:
transmit, to the first apparatus before the first positioning measurements are received, a configuration for obtaining the first positioning measurements.

36. The apparatus as claimed in claim 21, wherein at least one of the first and/or second apparatus is an access point and/or a user equipment.

37. A method for an apparatus for a first apparatus, the method comprising:
performing first positioning measurements using beamforming on transmissions made by a first user equipment to obtain first soft positioning information relating to the location of the first user equipment; and
providing the first soft positioning information to at least one of a second apparatus and/or a location function located in a core network.
